(19) United States
(12) Patent Application Publication
(10) Pub. No.: US 2025/0358580 A1
(43) Pub. Date: Nov. 20, 2025

(54) SEPARATION AND RENDERING OF HEIGHT OBJECTS

(71) Applicant: DOLBY LABORATORIES LICENSING CORPORATION

(72) Inventors: Zhiwei SHUANG, Beijing (CN); Yuanxing MA, Beijing (CN); Jundai SUN, Beijing (CN); Yang LIU, Beijing (CN); Ziyu YANG, Beijing (CN)

(73) Assignee: DOLBY LABORATORIES LICENSING CORPORATION, (US)

(21) Appl. No.: 18/874,428

(22) PCT Filed: Jun. 23, 2023
(86) PCT No.: PCT/US2023/068969

§ 371 Date: Dec. 12, 2024

Related U.S. Application Data
(60) Provisional application No. 63/495,515, filed on Apr. 11, 2023.
(60) Provisional application No. 63/509,232, filed on Jun. 20, 2023.

(30) Foreign Application Priority Data
Jun. 27, 2022 (WO) PCT/CN2022/101568

(51) Int. Cl. H04S 1/00

(52) U.S. Cl. CPC H04S 1/00; H04S 2400/11; H04S 2400/13; H04S 2400/15; H04S 2420/01; H04S 2420/07

(57) ABSTRACT

The present disclosure relates to a method and system for processing audio, as well as a computer program product comprising instructions which, when the program is executed by a computer, causes the computer to carry out the method. The method comprises obtaining an input audio signal and processing the input audio signal to extract a height audio object from the input audio signal, wherein the height audio object is extracted using a source separation module configured to extract an audio object of a predetermined height audio source type. The method further comprises rendering the input audio signal to a multi-channel presentation such that the at least one height audio object is included in at least one height channel of the multi-channel presentation.

### CROSS-REFERENCE TO RELATED APPLICATIONS

This application claims priority to U.S. provisional application Ser. No. 63/509,232, filed Jun. 20, 2023, U.S. provisional application Ser. No. 63/495,515, filed Apr. 11, 2023, and International application no. PCT/CN2022/101568, filed Jun. 27, 2022, each of which is incorporated by reference in its entirety.

### FIELD

The present invention relates to a method for processing audio signals.

### BACKGROUND

Today, audio content is captured using a large variety of devices ranging from smart devices (such as smartphones, smartwatches and tablets) to professional recording devices with expensive and high-quality microphone elements. The vast majority of all audio content captured today is so-called User Generated Content (UGC), and most UGC is captured using microphones with limited performance and distributed (e.g. uploaded to a streaming service) with minimal or no post-processing and, because the process for capturing and distributing UGC is so simple, it has rapidly become widely adopted.

For Professionally Generated Content (PGC) the source audio content often comprises many separate channels (e.g. one or more channels for dialogue, one or more channels for music and one or more channels for effects) and mixing engineers perform sophisticated audio processing to form well-balanced audio presentations suitable for rendering to e.g. a 5.1 surround sound system or binaural headphones.

UGC often comprises few, or only a single, captured channel, and is typically not subject to sophisticated manual post-processing by a mixing engineer. For example, in UGC, a target audio source (e.g. speech or music) may be recorded with an integrated microphone in a smartphone, held at some distance from the target audio source, wherein the microphone also captures background audio and noise that degrades the capture quality of the target audio source. Additionally, in many situations, the captured microphone signal is a mono audio signal meaning that the signal features very limited, or no, spatial properties.

To this end, various automatic post-processing techniques for enhancing UGC have been proposed to e.g. improve intelligibility and reduce noise. Examples of such automatic post-processing includes using speech separators for extracting the speech content from an UGC signal and suppress background audio and noise to make the speech more intelligible. Further examples of automatic post-processing that can be used to enhance UGC include EQ-processing, volume adjustments and reverb processing.

### SUMMARY

A drawback with the existing solutions for processing audio content (especially UGC) is that while e.g. speech separation, noise suppression, EQ-processing, leveling, reverb-processing etc. can enhance the perceived intelligibility and quality of the sound during playback, the resulting audio content would lack spatial acoustic properties (e.g. temporal and spectral cues for source localization) and result in a bland or non-immersive impression when reproduced in a spatial format. As an example, a mono audio signal recorded by a capture device carries no spatial information indicating the position of audio sources relative the capture device used to capture the audio sources. As a further example, a stereo audio signal captured by a pair of microphones of a smart device or a binaural capturing device may carry spatial information indicating the position of audio sources in a horizontal plane, however the stereo audio signal will still carry no information about height (elevation) of the audio sources. To this end, when rendering UGC to immersive multi-channel presentation formats (e.g. 2.0.2, 5.1.2, 5.1.4, 7.1.2, or 7.1.4 formats) the resulting presentation lacks spatial acoustic properties that existed in the environment in which the UGC was recorded.

It is a purpose of the present disclosure to present methods and systems for processing and rendering audio content, especially UGC content, which brings back or enhances the spatial properties when reproduced in multi-channel formats.

According to a first aspect of the present invention there is provided a method for processing audio. The method comprises obtaining an input audio signal and processing the input audio signal to extract a height audio object from the input audio signal. The height audio object is extracted using a source separation module configured to extract an audio object of a predetermined height audio source type. The method further comprises rendering the input audio signal to a multi-channel presentation such that the at least one height audio object is included at least in at least one height channel of the multi-channel presentation.

With the at least one height audio object being included in at least at least one height channel it is meant that the height audio object is rendered to at least one height channel of the multi-channel presentation and that the height audio object optionally also is rendered to one or more non-height channels. In some embodiments, the at least one height audio object is rendered to at least one non-height channel in addition to the at least one height channel. Alternatively, in some embodiments. the at least one height audio object is rendered only to one or more height channels of the multi-channel presentation.

That is, even for simple input audio signals (e.g. mono audio signals, stereo audio signals or binaural audio signals), at least one height audio object of a height audio source type is extracted and rendered to at least one height channel of a multi-channel presentation to form a presentation with enhanced spaciousness. UGC content in the form of a mono audio signal captured with a single microphone, or stereo or binaural audio signals captured with a pair of horizontally separated microphones (e.g. a pair of wireless earbuds) carries no information regarding the height of captured audio sources. However, with the above method, height audio objects of a predetermined type present in such audio signals may be automatically moved (panned) to at least one height channel of the multi-channel presentation. This results in a distribution of audio objects between height and horizontal channels that may enhance the perceived immersion for a listener.

Another benefit of the method according to the first aspect of the present invention is that the method can be computationally light-weight, making it well suited for implementation on computationally constrained devices. Some recording devices rely exclusively on multiple microphones to estimate the height of audio objects by using a time or intensity based analysis between respective microphone signals, however this height estimation process may be computationally heavy and challenging to implement on portable and power-constrained devices such as smartphones or wireless headphones. Furthermore, the reliability of such height estimation techniques are sensitive to the orientation of the recording device when recording content, and for some orientations (e.g. when the recording microphones are approximately aligned in the horizontal plane) height estimation will typically become unreliable or even impossible. The method according to the first aspect of the invention, however, can be very efficient and can be said to be input agnostic meaning that height audio objects can be extracted efficiently regardless of the orientation of the recording device, and even be applied to mono audio signals. The method according to the first aspect of the invention can be used instead of, or in addition to, time or intensity based analysis.

With a height audio source type it is meant audio content associated with a source that commonly or mostly is located above a user recording an audio signal. In other words, any audio content that a listener will associate with a direction of incidence from above the listener is a candidate for a height audio source type. As an illustrative example, most audio content is recorded on ground level (e.g. in the street), meaning that any sound characteristic for flying objects (birds, airplanes, drones) are candidates for a height audio source type.

An extracted audio object may be represented with an audio object signal comprising the isolated sound of the height audio source type. In some embodiments, each source separation module is configured to extract audio content associated with an audio object type for every time segment of the input audio signal. If the height audio source type is not present in one or more time segments of the input audio signal the audio object will be substantially silent (i.e. contain no audio content) for these time segments and if the height audio source type is present in the input audio signal the sound of the audio source type will be included in the audio object signal. Alternatively, it is envisaged that the source separation module is configured to generate an audio object signal only when audio associated with the height audio source type is present (e.g. exceeds a predetermined energy or level threshold).

In some embodiments, the height audio source type comprises at least one of manmade sounds associated with height (e.g. the sound of blade rotating in the air, the vibrational sound caused by mechanical propulsion systems and the sound of explosive combustion), sounds made by alive objects associated with height (e.g. sound associated with an animal using aerial locomotion and sound associated arboreal animals) and sounds of nature associated with height (e.g. the sound of a weather phenomenon). By extracting audio objects associated with any of these types of height audio sources a believable and convincing distribution of height audio objects in height can be achieved, which further enhances immersion.

Manmade sounds associated with height may also comprise music or song. For example, a user recording an orchestra or opera is often in the audience which is positioned lower than the stage where the orchestra or singer is performing meaning that the music is perceived as coming from above.

In some embodiments, the method further comprises processing the input audio signal to also extract a non-height audio object from the input audio signal. The non-height audio object may be extracted using a source separation module configured to extract an audio object of a predetermined non-height audio source type, wherein rendering the input audio signal further comprises rendering the non-height audio object to at least one non-height channels of the multi-channel presentation. The non-height audio objects will accordingly be rendered to at least to one or more horizontally distributed channels in the multi-channel presentation. Height audio objects and non-height audio objects are thus extracted separately, and rendered differently, to obtain a rendered multi-channel presentation with a believable distribution of audio objects in height which enhances immersion.

Examples of non-height audio source types includes speech, sounds made by manmade objects not associated with height (e.g. the of diesel or petrol engines or the sound of tires rolling on the ground), sounds made by alive objects not associated with height (e.g. the sound associated surface dwelling creatures such as cats, dogs or cows) or sounds made by nature not associated with height (e.g. the sound ocean waves hitting the shore).

The non-height audio object types can be extracted implicitly. For example, any audio content not included in the one or more height audio object types may be defined as a non-height audio object.

According to a second aspect of the invention there is provided a computer program product comprising instructions which, when the program is executed by a computer, causes the computer to carry out the method according to the first aspect.

According to a third aspect of the invention there is provided a system comprising one or more processors configured to carry out the method according to the first aspect.

### DESCRIPTION OF THE DRAWINGS

Aspects of the present invention will be described in more detail with reference to the appended drawings, showing exemplary embodiments.

FIG. 1 is a block chart illustrating an audio processing system according to some embodiments.

FIG. 2 is a flowchart describing a method for processing audio according to some embodiments.

FIG. 3 is a block chart illustrating an audio processing system with two source separation blocks according to some embodiments.

FIG. 4 shows a source separation block according to some embodiments.

FIG. 5 shows a neural network based source separation block according to some embodiments.

FIG. 6 shows a filter based source separation block according to some embodiments.

FIG. 7 depicts schematically a 2.0.2 loudspeaker layout of a media system.

### DETAILED DESCRIPTION

Systems and methods disclosed in the present application may be implemented as software, firmware, hardware or a combination thereof. In a hardware implementation, the division of tasks does not necessarily correspond to the division into physical units; to the contrary, one physical component may have multiple functionalities, and one task may be carried out by several physical components in cooperation.

The computer hardware may for example be a server computer, a client computer, a personal computer (PC), a tablet PC, a set-top box (STB), a personal digital assistant (PDA), a cellular telephone, a smartphone, an AR/VR wearable, automotive infotainment system, a web appliance, a network router, switch or bridge, or any machine capable of executing instructions (sequential or otherwise) that specify actions to be taken by that computer hardware. Further, the present disclosure shall relate to any collection of computer hardware that individually or jointly execute instructions to perform any one or more of the concepts discussed herein.

Certain or all components may be implemented by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system (e.g., computer hardware) that includes one or more processors. Each processor may include one or more of a CPU, a graphics processing unit, and a programmable DSP unit. The processing system further may include a memory subsystem including a hard drive, SSD, RAM and/or ROM. A bus subsystem may be included for communicating between the components. The software may reside in the memory subsystem and/or within the processor during execution thereof by the computer system.

The one or more processors may operate as a standalone device or may be connected, e.g., networked to other processor(s). Such a network may be built on various different network protocols, and may be the Internet, a Wide Area Network (WAN), a Local Area Network (LAN), or any combination thereof.

The software may be distributed on computer readable media, which may comprise computer storage media (or non-transitory media) and communication media (or transitory media). As is well known to a person skilled in the art, the term computer storage media includes both volatile and non-volatile, removable and non-removable media implemented in any method or technology for storage of information such as computer readable instructions, data structures, program modules or other data. Computer storage media includes, but is not limited to, physical (non-transitory) storage media in various forms, such as EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer. Further, it is well known to the skilled person that communication media (transitory) typically embodies computer readable instructions, data structures, program modules or other data in a modulated data signal such as a carrier wave or other transport mechanism and includes any information delivery media.

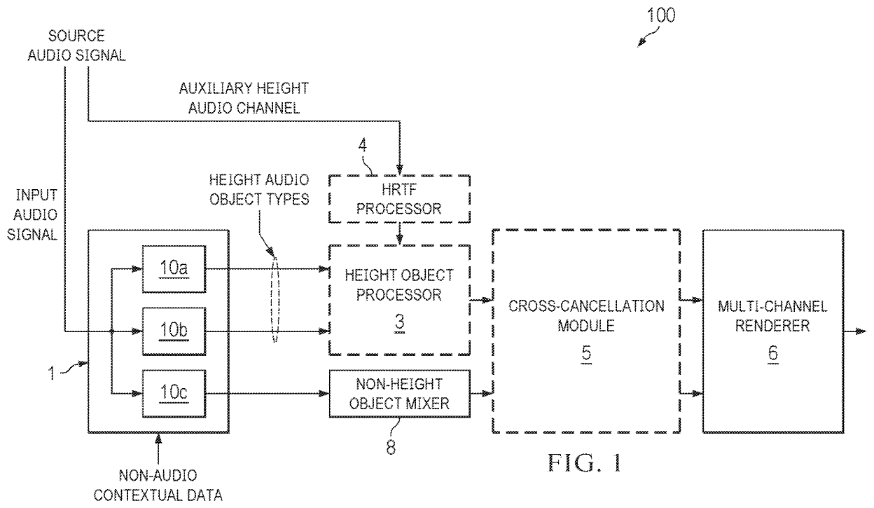

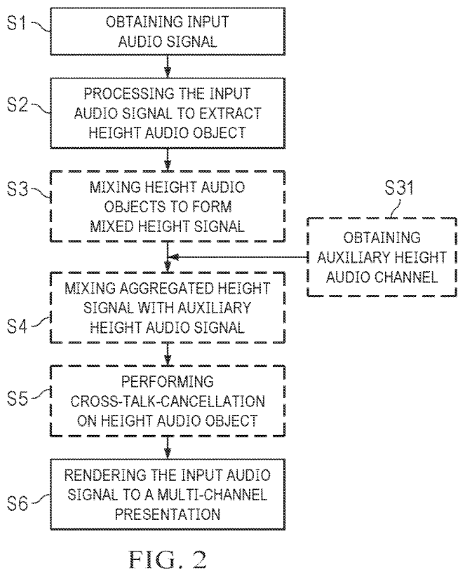

FIG. 1 is a block chart showing schematically an audio processing system 100 according to some embodiments. With further reference to the flow chart in FIG. 2 the audio processing system 100 will now be described in detail. At step S1 an input audio signal is obtained by a source separation block 1 comprising at least one source separation module (e.g., 10a, 10b). The input audio signal may comprise one or more channels. Generally, the input audio signal comprises one more horizontal channels, e.g. two or more horizontal channels or three or more horizontal channels, but no height channel. For example, the input audio signal is a mono audio signal (with one channel), a stereo or binaural audio signal (with two channels) or a surround sound audio signal (with more than two channels), such as a 5.1 signal with six channels including an LFE-channel or a 7.1 signal with eight channels including an LFE-channel.

For example, a mono input audio signal or stereo input signal may be captured with a recording device (e.g. a smartphone or a tablet computer) with a mono or stereo microphone configuration.

A binaural audio signal may be acquired using a dummy-head microphone or, as is more common for UGC, using headphones (e.g. wireless headphones or earbuds) provided with separate microphones for recording binaural audio signals.

Irrespective of the number of channels in the input audio signal, the input audio signal will in most cases contain audio content being a mix of many types of audio sources. As an example, if the audio signal is recorded during an interview outdoors it may comprise a mix of the voice of the interviewer, the voice of the interviewee, voices from other people nearby, traffic noise, birdsong, the sound of an airplane passing overhead and different types of background noise, such as stationary white noise.

The source separation block 1 is configured to process the input audio signal to extract at least one height audio object of a predetermined height audio source type from the input audio signal at step S2. More specifically, the source separation block 1 comprises at least one source separation module (e.g., 10a, 10b), wherein each source separation module (e.g., 10a, 10b) is configured to extract a respective height audio object of a respective predetermined height audio source type. Each source separation module (e.g., 10a, 10b) outputs an object audio signal carrying audio content associated with predetermined height audio source type.

In some embodiments, each source separation module (e.g., 10a, 10b) is configured to extract a height audio object of a predetermined height audio source type, wherein the height audio source type covers or includes one or more of manmade sounds associated height, sounds made by alive objects associated with height or sounds of nature associated with height. Exemplary sub-categories under manmade sounds associated with height are the sound of a blade rotating in the air (e.g. the sound of a helicopter, drone, propeller engine or jet engine), the sound caused by manmade objects flying through the air (the sound of an airplane or balloon moving through the air) and the sound of combustion (e.g. the sound of fireworks exploding). Exemplary sub-categories under alive objects associated with height are sounds associated with an animal using aerial locomotion (e.g. the vocal sounds of bats, birds or insects or the sound of bats, birds or insects moving through the air) and sounds associated sound associated arboreal animals (e.g. the vocal sounds of sloths and/or monkeys/primates and the sound of sloths and/or monkeys/primates moving in trees). Exemplary sub-categories under nature sounds associated with height are weather sounds (e.g. the sound of thunder, rain, wind and hail) and landscape feature sounds associated with height (the sound of a waterfall and the sound of rattling leaves).

As an example, source separation module 10a is configured to extract a height audio object type that contains (if present in the input audio signal) manmade sounds associated with height and source separation module 10b is configured to extract a height audio object of a more specific height audio source type, such as only the sound of a blade rotating through the air and/or the sound of insects.

In some embodiments, more than one source separation module 10a, 10b is present in the source separation block 1, wherein each source separation module 10a, 10b extracts a height audio object of a different respective height audio source type. For example, one source separation module 10a extracts a height audio object comprising any manmade sound associated with height and another source separation module 10b extracts a height audio object comprising birdsong. Generally, it may be challenging to design a single source separation module 10a, 10b that reliably extracts a large variety of different height audio object types with different acoustic properties. For example, as will be described below, each source separation module 10a, 10b may comprise a filter for extracting the different types of height audio objects and designing a single filter that covers all conceivable height audio object types (manmade and nature sounds associated as well as sounds associated with alive objects with height) without also covering one or more non-height audio object types (such as speech or traffic sounds) may be difficult. Thus, using multiple source separation modules 10a, 10b, wherein each source separation module extracts a single specific type of height audio object (e.g. birdsong) or a group of specific types of height audio objects (e.g. all manmade sounds associated with height) with similar frequency characteristics, may facilitate more reliable and accurate extraction of various types of height audio objects with little or no erroneous extraction of non-height object types.

The source separation modules 10a, 10b extract a respective height audio object type and each extracted type of height audio object is represented with an audio object signal comprising the sound of audio objects having the predetermined type. The audio object signals (each carrying a respective type of audio object) are optionally provided to a height object processor 3 which at optional step S3 mixes the audio object signals into an mixed height signal and/or applies a predetermined or adaptive gain for each of the audio object signals. The mix height signal may thus comprise a mix of at least two different types of audio objects.

In some embodiments, wherein only a single type of height audio object is extracted, the mixing at S3 can be skipped. Alternatively, the height object processor 3 only adjusts the gain (e.g. based on an identified scene type) of the single type of height audio object without performing any mixing.

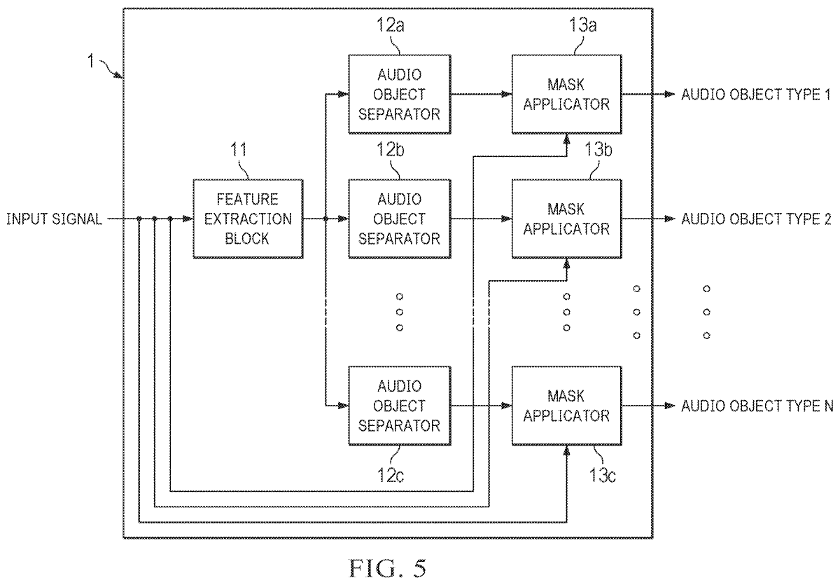

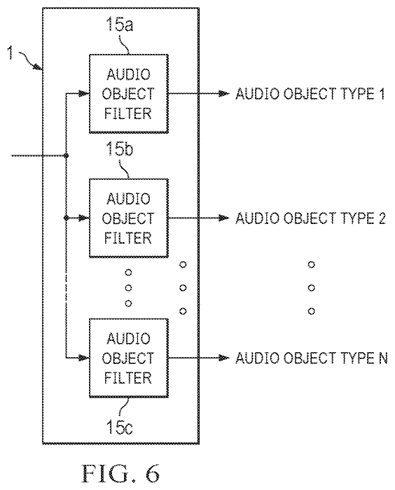

Generally, the source separation block 1 is configured to separate the input audio signal into N types of height audio objects wherein N is equal to or greater than one. The source separation block 1 can be implemented in different versions, e.g. it can rely on filtering to perform the separation and/or rely on neural networks to perform the separation as will be described below in connection to FIG. 5 and FIG. 6.

The mixed height signal is provided to a multi-channel renderer 6 which renders the mixed height signal to the multi-channel presentation at step S6, such that the height audio object types of the mixed height signal are rendered to at least one height channel of the multi-channel presentation. The rendering performed by the multi-channel renderer 6 involves rendering the mixed height signal to one or more height channels of the multi-channel format. For example, if the multi-channel format is a 2.0.2 format, a 5.1.2 format or a 7.1.2 format the mixed height signal (comprising a mix of two or more types of height audio objects) may be rendered to the 0.0.2 height channels.

In some embodiments, the height audio object signals extracted by the source separation modules 10a, 10b are provided directly to the renderer 6 which renders the height audio object signals to one or more height channels of the multi-channel presentation.

The renderer 6 may be configured to assign predetermined spatial positions to each height audio object signal. For instance, an object based spatial renderer renders spatial audio objects to presentation channels based on the spatial audio object's position. As an example, each height audio object signal may be rendered to a zenith elevation or 45° elevation so as to be perceived as coming from above the listener. In some embodiments, the height audio object signal comprises two channels whereby the renderer 6 is configured to render the two channels of the height audio object signals to two height channels with a predetermined elevation and channel separation angle.

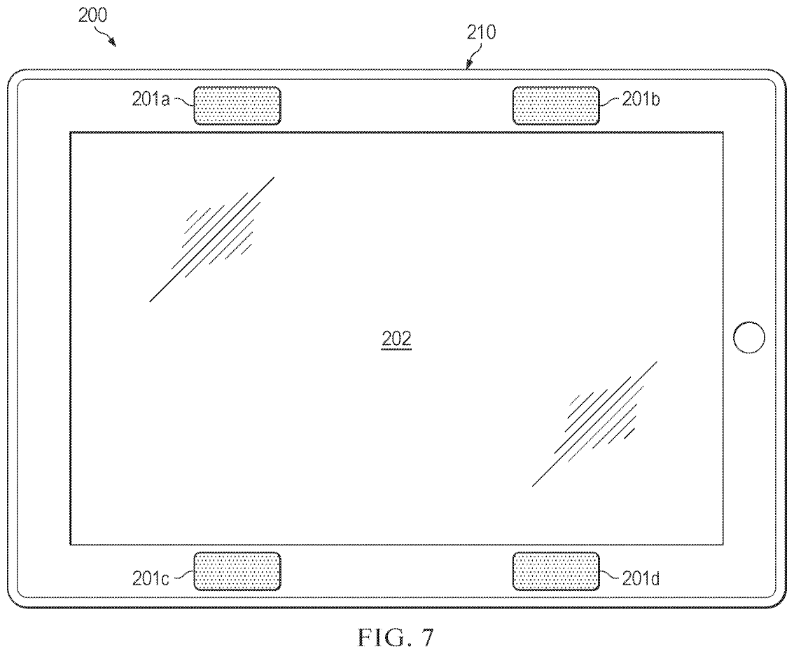

Optionally, the mixed height signal or audio object signal(s) are provided to a cross-talk-cancellation module 5 which performs cross-talk-cancellation processing at step S5 on the mixed height signal or audio object signal(s) to reduce or remove cross-talk between at least two height channels in the rendered presentation. Cross-talk-cancellation is especially useful for binaural input audio signals since this may ensure that some binaural properties are maintained when the audio object is presented to a user. The cross-talk-cancellation processing will be described in further detail below, in connection to FIG. 7.

Accordingly, even though the input audio signal as such does not comprise a separate height audio channel (e.g. the input audio signal is a mono audio signal) one or more types of height audio objects have been extracted from this signal and used to create a multi-channel presentation wherein the height channels carry the extracted height audio objects to improve the spatial immersion for a user consuming the content.

In some embodiments, the source separation block 1 is further configured to extract one or more types of non-height audio objects. For example, a source separation module 10c of the source separation block 1 may be configured to extract a non-height audio object of a predetermined non-height audio source type. The non-height audio source type may e.g. be speech, sounds associated with by alive objects associated with non-height (the sound of cats or the sound of dogs) or manmade sounds associated with non-height (e.g. traffic noise, background voices). The non-height audio object(s) are represented with respective non-height audio object signal(s) that optionally are provided to a non-height object processor 8 which mixes the non-height audio object signal(s) and/or applies predetermined or adaptive gains. In analogy with the discussion of multiple source separation modules 10a, 10b, the source separation block 1 may be provided with two or more source separation modules, each configured to extract an audio object of a respective predetermined non-height audio source type.

While separate extraction of non-height audio object types is associated with some benefits (such as allowing the relative reproduction level of non-height audio objects to be adjusted depending on e.g. a detected acoustic scene type), this feature is optional. Thus, in some embodiments, only one or more height audio object types are extracted and the non-height audio object type(s) are determined implicitly as any residual audio content that is present in the input audio signal but not in any of the extracted height audio object types. The residual audio content may be provided directly to the multi-channel renderer 6 for rendering to non-height channels in the multi-channel presentation.

Optionally, an auxiliary height audio channel is obtained at S31 and also provided to the height object processor 3 which mixes it with the mixed height audio signal. The auxiliary height audio channel may be extracted from a source audio signal which comprises a non-height channel and a height channel. The non-height channel is used as the input audio signal (from which one or more height audio objects may be extracted) and the height audio channel is used as the auxiliary height audio channel. For example, in some situations, there may already exist a preliminary height audio channel which already comprises one or more types of height audio objects. However, some height audio object types may still remain in the non-height channel and these may according to the present method be extracted and mixed together with the auxiliary height audio channel. To this end, the audio processing system 10 may not only be used to extract height audio object types when no height channel is available, it may also be used to extract further height audio object types in addition to some preliminary height audio object types present in the height channel of the source audio signal.

In some implementations, the source separation block 1, the height object processor 3 and/or the non-height object mixer 8 is further configured to obtain non-audio contextual data associated with the input audio signal and/or associated with a video or image captured concurrently with the input audio signal. The non-audio contextual data is indicative of the context for the input audio signal. For example, the non-audio contextual data includes the results of a semantic or keyword analysis of the input audio signal, geographical position data associated with the recording location of the input audio signal, information regarding identified objects in an image or video captured concurrently (e.g. with the same user device) with the input audio signal or capture properties associated with the concurrently captured video or image.

The non-audio contextual data can be used by the source separation block 1 to selection which source separation modules 10a-c that should be used in the source separation block 1. Alternatively, the non-audio contextual data can be used the height object processor 3 and/or the non-height object mixer 8 to adjust the gain (e.g. completely silence) some height/non-height audio objects.

As seen in FIG. 1, non-audio contextual data is provided to the source separation block 1 which selects, based on the non-audio contextual data, at least one source separation module 10a from a group of source separation modules. The group of source separation modules comprises a plurality of separation modules, each configured to extract a height audio object of a predetermined height audio source type and each being associated with a respective type of non-audio contextual data. For example, if the non-audio contextual data comprises position data indicating that the input audio signal was recorded indoors or comprises data indicating that a video or image captured concurrently with the input audio signal comprises objects that are associated with an indoor environment (e.g. a TV, a kitchen or a desk) the source separation block 1 may select a source separation module 10a associated with indoor non-audio contextual data type and optionally refrain from selecting a source separation module 10b associated with outdoor non-audio contextual data type.

In this way, the audio processing system 100 can according to some embodiments refrain from using all source separation modules 10a-c at all times and only use the selected source separation modules 10a-c that extract height audio source types that are likely active based on the non-audio contextual data.

It is understood that “selecting” a source separation module comprises activating/deactivating one or more source separation modules 10a-c which in effect constitutes a selection of which modules that are used (active). Deactivation can be achieved in in the source separation block wherein the processing of a deactivated source separation module 10a-c is merely omitted. However, deactivation can also be performed in the height object processor 3 and/or the non-height object mixer 8 which silences the associated extracted height audio objects to be deactivated.

Additionally or alternatively, the above described selection of source separation modules 10a-c can be based on an identified acoustic scene which may in turn be based on the non-audio contextual data.

In FIG. 2 the auxiliary height channel is mixed with the mixed height signal comprising a mix of the extracted audio object signals. However, it is understood that optional steps S3, S31 and S4 can be performed in a different order. For example, it is envisaged that the auxiliary height channel is mixed with the extracted audio object signal(s) in a single step to form the mixed height signal comprising a mix of the audio object signals and the auxiliary height audio channel.

The auxiliary height audio channel may be acquired with a recording device having two or more microphones that enable vertical source separation.

For example, a smartphone commonly features two or more microphones, and when the smartphone is held in portrait mode, oftentimes there is at least one microphone pointing upwards, and another microphone pointing downwards. With such a microphone arrangement, elevation related information could be extracted from the audio signals recorded by these microphones (using e.g. beam steering), and the elevation related information can be used to extract the auxiliary height audio channel from the two microphone signals.

For example, in frequency ranges where the upwards and downwards facing microphones have omnidirectional microphone pattern, the microphone pair could form a fixed or adaptive beamformer with which the sound events from non-horizontal elevations can be extracted and used as the auxiliary height audio channel.

As another example, in frequency ranges where the capturing device comprises a microphone having a polar microphone pattern, the microphone could be used to extract the auxiliary height audio channel directly.

Additionally, in some embodiments, the auxiliary height audio channel, be it a height-channel of a source audio signal or extracted from a recording device with multiple microphones, is processed with a height object classifier which separates the auxiliary height audio channel into height audio object types and non-height audio object types. Wherein the height audio object types are used in the auxiliary height audio channel and the non-height audio object types are discarded or combined with the non-height audio object types extracted from the input audio signal. That is, even when an auxiliary height audio channel is present and comprises actual height audio objects the audio processing system 100 may relocate these preliminary height audio objects to non-height channels in the multi-channel presentation.

In some embodiments, the auxiliary height audio channel is a not a binaural audio signal (e.g. the auxiliary height audio channel is a mono channel) while the input audio signal, and the different types of height audio objects extracted therefrom, are binaural. In such embodiments, the auxiliary height audio channel may be binauralized using an HRTF processor 4 prior to being mixed with the extracted height audio object types in the height object processor 3. The HRTF processor 4 processes the auxiliary height audio channel with an HRTF which as such is known in the art. For example, if the auxiliary height audio channel is a mono channel, the HRTF processor 4 may process the mono channel with a HRTF to generate two binaural channels, with the mono audio channel treated as an audio object, placed at a predetermined elevation and azimuth angle.

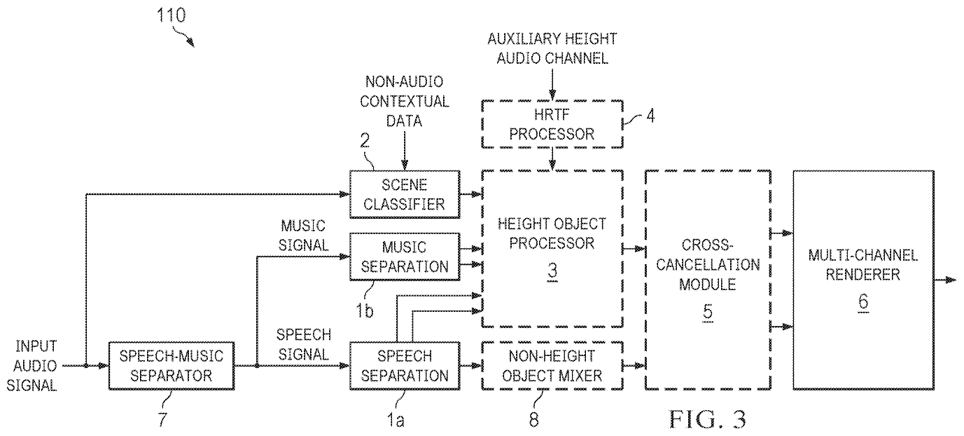

In FIG. 3 an audio processing system 110 with two source separation blocks 1a, 1b is shown. The audio processing system 110 of FIG. 3 differs from the audio processing system 100 of FIG. 1 in that it comprises a speech-music separator 7, two source separation blocks 1a, 1b, one for speech dominated content and one for music dominated content, and in that it comprises a scene classifier that is used to control the gain(s) applied by the height object processor 3.

The speech-music separator 7 obtains the input audio signal and separates the input audio signal into two separate signals, a speech signal comprising speech content and a music signal comprising music content. The speech-music separator 7 may be configured to divide the input signal such that all content is preserved and present in either the speech signal or the music signal with limited or no overlap. For example, the speech-music separator 7 may be configured to include any music content in the music signal and any other content in the speech signal (including some content which is neither speech nor music, such as the sound of a helicopter). The speech-music separator 7 may comprise a trained neural network for performing the speech-music separation.

The speech signal and music signal are provided to a speech separation block 1a and music separation block 1b respectively. Each separation block 1a, 1b comprises at least one source separation module configured to extract a height audio object of a respective predetermined height audio source type that may be present in the speech and music signal, respectively. For example, the speech separation block 1a comprises at least one source separation module configured to extract a height object belonging to a least one of the following types: manmade sounds associated height, sounds made by alive objects associated with height and sounds of nature associated with height. The music separation block 1b comprises one or more source separation modules configured to extract a respective type of instrument (strings, woodwinds, brass, percussion) as a height audio object and/or a specific instrument (e.g. violin, trombone or trumpet) as a height audio object. While music does not contain audio objects which are as such associated with a height (compared to e.g. the sound of an airplane than in most cases will be perceived as a sound which is associated with a height), it is contemplated that by identifying any audio object in the music signal, and treating it as a height audio object in accordance with this disclosure, may enhance the spaciousness and immersion for the listener. In some embodiments, as mentioned in the above, all music content may be treated as a height audio object type providing enhanced immersion where it may appear to the listener that the music is coming from a stage positioned slightly above the listener.

Optionally, each source separation block 1a, 1b may also comprise one or more non-height source separation modules configured to extract at least one non-height audio object type for rendering to the multi-channel presentation. For example, the speech source separation block 1a may comprise a source separation module configured to extract speech as a type of non-height audio object.

By splitting the input audio signal into two portions, based on content, it is easier to realize accurate separation blocks 1a, 1b. Preferably, the input audio signal is split into at least two content types, wherein the audio objects extracted from each content type contains similar harmonic or specific time-frequency pattern as this may improve separation performance.

Any types of height or non-height audio objects extracted by each source separation block 1a, 1b is provided to the height object processor 3 or the non-height object processor 8 and combined into a mixed height audio signal or a mixed non-height audio signal, respectively, with a predetermined or adaptive gain for each type of audio object.

The audio processing system 110 also comprises a scene classifier 2. The scene classifier 2 is configured to analyze the input audio signal and determine an acoustic scene type of the input audio signal. In some embodiments, the scene classifier 2 is configured to determine if the input audio signal is of an indoor scene type or of an outdoor scene type. Additionally, the scene classifier may be configured to determine if the input audio signal is of additional acoustic scene types, such as a transportation (commute) scene, nature scene or urban scene.

With the term “acoustic scene classification” it is meant the identification of high-level semantic properties of recorded audio content which indicates the environment in which content has been recorded. For example, a voice recorded outdoors sounds different from the same voice recorded indoors, due to e.g. different reverberation effects and echo. An acoustic scene classifier 2 analyzes the audio content of the input audio signal and determines an acoustic scene for the audio content. The acoustic scene classifier 2 may e.g. be configured to analyze the energy spectrogram of the input audio signal, or use a trained neural network, to determine the acoustic scene of the input audio signal.

It is also envisaged that the scene classifier 2 may analyze one or more extracted height or non-height audio objects to determine the acoustic scene type. While each extracted audio object type comprises only a subset of the information available in the input audio signal, it may still be possible for the scene classifier 2 to accurately determine the acoustic scene type based on one or more extracted audio object type. For instance, the scene classifier 2 may be trained to classify the scene as an outdoor scene given an input of one or more extracted audio objects comprising the sound of rustling leaves, wind or raindrops hitting the ground.

Additionally or alternatively, the scene classifier 2 obtains non-audio contextual data associated with the input audio signal and determines, based on the non-audio contextual data, the acoustic scene type. The non-audio contextual data may indicate a media capture mode associated with the input audio signal, the result of a semantic or keyword analysis of the input audio signal, and geographical position data associated with the recording location of the input audio signal. For example, if the input audio signal comprises speech, various keywords can be identified wherein the keywords will help the scene classifier 2 make a more informed decision regarding the current acoustic scene. For example, if keywords associated with objects, spaces or events that are typically indoors (e.g. “living room”, “couch”, “kitchen”, “stove” or) are detected it is likely that the acoustic scene is an indoor scene. Similarly, if keywords associated with objects, spaces or events that are typically outdoors (e.g. “tree”, “hike”, “bird”, “lake”, “ocean”) are detected it is likely that the acoustic scene is an outdoor scene. It is understood that any number of acoustic scenes can be detected, and not only an indoor scene or outdoor scene, wherein each scene is associated with one or more keywords.

The non-audio contextual data may be contextual data extracted from a video or image captured concurrently with the input audio signal. The input audio signal may for example be the recorded audio track of a video file meaning that the input audio signal is included in the same media file or media stream as the video. For example, the non-audio contextual data may indicate one or more detected objects in the video or image (e.g. birds, trees, people) or capture properties associated with the video or image (e.g. scene brightness, shutter speed, ISO level). This information can be used by the scene classifier 2 to make a more accurate classification of the scene. For example, if one or more trees, the sky or a lake is identified in the video or image it is likely that the acoustic scene is an outdoor scene. As another example, if the scene brightness is low, shutter speed long or ISO level high it is likely that the video or image is captured in a dim indoor setting meaning it is likely that the acoustic scene is an indoor scene.

The above exemplary information indicated by the non-audio contextual data is merely exemplary and many other types of information could also be included. For example, some capturing devices allow the user to select a specific capture mode for video or images captured concurrently with the input audio signal (e.g. indoor capture mode, food capture mode, landscape capture mode, starry sky capture mode etc.). Non-audio contextual data indicating the capture mode of associated image or video can be used to determine the acoustic scene. For example, if the capture mode is an indoor capture mode or food capture mode the acoustic scene is likely and indoor capture scene and if the capture mode is a landscape capturing mode or starry sky capturing mode the acoustic scene is likely an outdoor scene.

While certain examples of the non-audio contextual data are presented in connection to the scene classifier 2 it is understood that the same examples of the non-audio contextual data are applicable to other components using the non-audio contextual data in embodiments of the invention (e.g. the source separation block that may use the non-audio contextual data to select appropriate source separation modules).

The scene classifier 2 informs the height object processor 3 and/or the non-height object processor 8 of the determined acoustic scene. The height and non-height object processor 3, 8 may accordingly be configured to adaptively control the gain applied to at least one height object signal based on the determined acoustic scene. In some embodiments, each height and/or non-height audio object type is associated with at least one acoustic scene type. Accordingly, a first (height or non-height) audio object type is associated with a first acoustic scene type (e.g. birdsong is associated with an outdoor scene) and a second (height or non-height) height object type is associated with a second acoustic scene type (e.g. ceiling fan sound is associated with indoor scene). The height and non-height object processor 3, 8 are configured to increase the mixing gain of the audio object signals (carrying a respective object type) associated with the current acoustic scene and/or decrease (e.g. silence completely) the audio object(s) associated with a different acoustic scene. For example, if the acoustic scene is an indoor scene the gain of a birdsong audio object type is decreased (or silenced completely) since birdsong is not expected indoors, whereas the gain of a ceiling fan audio object type is decreased since a ceiling fan is likely used indoors.

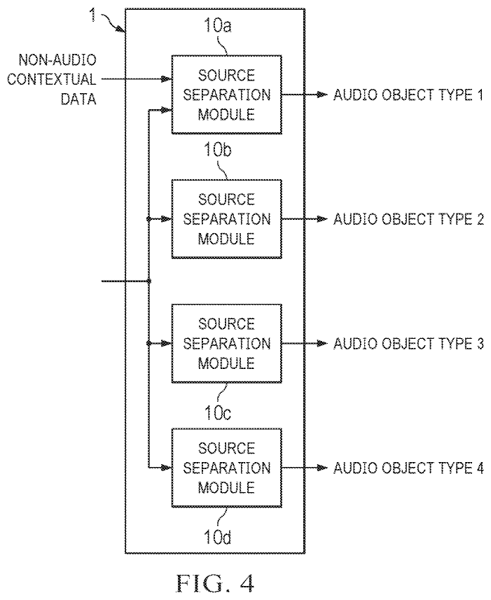

Turning to FIG. 4, a source separation block 1 according to some embodiments is shown. The source separation block 1 comprises a plurality of source separation modules 10a-d. Source separation module 10a is configured to extract a height audio object type and source separation modules 10b-d are configured to extract respective non-height audio object types, sometimes also referred to as “residual” audio object types. The extracted height audio object type is optionally provided to a height object processor (see FIG. 1 or FIG. 3) and rendered to at least one height channel in the multi-channel presentation. The non-height audio object types are, optionally, also subject to some mixing prior to being rendered to at least one non-height channel in the multi-channel presentation.

In one exemplary implementation, source separation module 10a is configured to extract sounds made by alive objects associated with height (e.g. birdsong), source separation module 10b is configured to extract speech, source separation module 10c is configured to extract sounds associated with alive objects without height (e.g. cat or dog) and source separation module 10d is configured to extract background audio, that is, any audio content not extracted by source separation modules 10a-d. The audio extracted by source separation module 10a is used as a height audio object type and the remaining audio objects extracted by source separation module 10b-d are used as respective non-height audio object types.

It is understood that the source separation block shown in FIG. 4 is merely exemplary and that many variations are possible. For example, more or fewer height object separation modules 10a may be used and/or more or fewer non-height separation modules 10c-d may be used. Additionally, it is noted that source separation module 10d, for explicitly determining the background audio not covered by any of the other source separation modules 10a-c, can be omitted as the background audio may be implicitly determined by the other source separation modules 10a-c. For example, the background audio content can be determined using fundamental operations on the input audio signal and the extracted audio object types (e.g. subtracting the extracted audio object types from the input audio signal).

In the above, in connection to FIG. 1, it has been described that non-audio contextual data can be provided to the source separation block 1 wherein the source separation block 1 selects the source separation modules 10a-d based on the non-audio contextual data. As shown in FIG. 4, it is also envisaged that the non-audio contextual data can be provided directly to the one or more source separation module 10a to assist the separation processing of the source separation module 10a. It is envisaged that the processing of the source separation module 10a can be fine-tuned based on the non-audio contextual data or that the source separation module 10a can operate in different modes based on the non-audio contextual data.

As an example, source separation module 10a is configured to extract height audio object of a height audio source type corresponding to sound associated with a blade moving through the air (e.g. from the rotor of a drone, helicopter, turbojet engine or ceiling fan). If the non-audio contextual data indicates the context of the input audio signal is an outdoor scene, source separation module 10a may operate in a first mode configured to extract sound associated with the rotor of a drone, helicopter or turbojet (that may be heard primarily outdoors). On the other hand, if the non-audio contextual data indicates that the context of the input audio signal is an indoor scene, source separation module 10a may operate in a second mode configured to extract sound associated specifically with ceiling fan (that may be heard primarily indoors).

Additionally or alternatively to the non-audio contextual data, an identified acoustic scene may be provided to one or more of the source separation modules 10a-d wherein the source separation modules 10a-d are configured to perform extraction based on the acoustic scene. The acoustic scene, determined by the scene classifier, may in turn be based on non-audio contextual data and/or properties of the input audio signal.

In FIG. 5, one example implementation of a neural network based source separation block 1 is depicted. The source separation block 1 obtains an input audio signal and outputs N types of separated audio objects (height object types and/or non-height audio object types). The source separation block 1 comprises a common feature extraction block 11 trained to extract a set of features based on the input audio signal. For example, a set of features is extracted by the feature extraction block 11 for each time segment or time-frequency tile of the input audio signal. The feature extraction block 11 may comprise one or more neural network layers, such as one or more dense neural network layers, one or more convolutional neural network layers, one or more recurrent neural network layers or a combination thereof. The features extracted by the feature extraction block 11 may be latent features.

The same set of features extracted by the feature extraction block 11 is provided to each of N number of gain mask predictors 12a, 12b, 12c. Each of the gain mask predictors 12a, 12b, 12c is configured to generate a gain mask (soft mask) for isolating a respective (height or non-height) audio object. A gain mask comprises a plurality of gain values, one gain value for each time-frequency tile, that are configured to be applied to the input signal so as to remove approximately all audio objects except a target audio object (e.g. birdsong or speech). Inversely, the gain mask may comprise a plurality of gain values that are configured to be applied to the input signal to remove only the target audio object. In either case, each gain mask is configured to separate the target audio object from all other audio objects present in the input audio signal. Each gain mask may comprise binary gain values (i.e. either a one or a zero) to completely silence a time-frequency tile or let the time-frequency tile pass unprocessed. Each gain mask may also comprise “softer” gain values, that is, gain values that can also assume a range of values between zero and one.

The feature extraction block 11 and/or the gain mask predictors 12a, 12b, 12c may be provided with non-audio contextual data and/or information regarding the acoustic scene as side information allowing these networks to be trained specifically for different types of context and scenes.

At least one of the gain mask predictors 12a, 12b, 12c is configured to predict a gain mask for extracting an audio object associated with a height audio source type, such as manmade sounds associated with height (e.g. the sound of blade rotating in the air, the sound caused by manmade objects moving through the air and the sound of explosive combustion), sounds made by alive objects associated with height (sound associated with the movement of an animal using aerial locomotion and sound associated arboreal animals) or sounds of nature associated with height (e.g. weather sound or sounds associated with landscape features). Each gain mask predictor 12a, 12b, 12c may comprise one or more neural network layers trained to predict a gain mask for isolating the respective audio object based on the common set of features.

For example, the gain mask predictor 12a is configured to predict a gain mask for extracting birdsong and the gain mask predictor 12b is configured to predict a gain mask for extracting helicopter sound, based on the same set of features extracted by the feature extraction block 11.

Each gain mask is provided to a respective mask applicator unit 13a, 13b, 13c which applies the gain mask to the input signal to form the extracted audio objects. Continuing the example in the above, the audio object extracted by gain mask predictor 12a and mask applicator 13a will be isolated birdsong and the audio object extracted by gain mask predictor 12b and mask applicator 13b will be isolated helicopter sound.

Accordingly, the source separation block 1 extracts one or more different types of audio objects associated with height which can be rendered to the height channels of a multi-channel presentation to enhance spaciousness. Notably, the input audio signal could be a mono signal, a binaural signal, a stereo signal or a multi-channel signal meaning that audio object types associated with height can be extracted even for input audio signals without any height information, e.g. a mono signal captured with a smartphone. The extracted audio object types are then optionally provided to the non-height or height object processor or directly to the multi-channel renderer, as discussed in the above in connection to FIG. 1 in the above.

It is noted that the common feature extraction block 11, gain mask predictor 12a and mask applicator 13a together may form a first source separation module configured to extract a first audio object type. Analogously, the common feature extraction block 11, gain mask predictor 12b and mask applicator 13b may form a second source separation module configured to extract a second audio object type different from the first audio object type. Additional mask predictors 12c and mask applicators 13c can be added so as to extract N types of audio objects, wherein N is greater than or equal to one.

To train the feature extraction block 11 and audio object separators 12a, 12b, 12c a test audio signal can be provided wherein the test audio signal comprises a mix of audio object types. The test audio signal is provided to the feature extraction block 11 that extracts features and provides the features to the audio object separators 12a, 12b, 12c that predicts a gain mask for separating audio objects of the respective audio object type. In some embodiments, the predicted gain masks are compared to ground-truth gain masks extracted manually for separating the respective types of audio objects. Based on the difference between the ground truth gain masks and the predicted gain masks the internal weights of the audio object separators 12a, 12b, 12c and/or the feature extraction block 11 can be updated to reduce the difference and train the audio object separators 12a, 12b, 12c and/or the feature extraction block 11 to produce gain masks that are closer to the ground truth gain masks.

It is also envisaged that the predicted gain masks can be applied to the test audio signal to obtain predicted audio object signals that should capture audio objects of a respective type. By comparing the audio object signals with ground truth audio object signals comprising manually separated audio objects of the corresponding types the internal weights of the audio object separators 12a, 12b, 12c and/or the feature extraction block 11 can be updated.

It is also possible to use a separate feature extraction block 11 for each gain mask predictor 12a, 12b, 12c. A benefit with such embodiments is that each pair of feature extraction block 11 and gain mask predictor 12a, 12b, 12c form a standalone extractor model which can be trained separately and then combined with other standalone models. A trade-off with this solution is that as the number of audio object types increases the total model complexity grows linearly. To this end, it is beneficial, for computational complexity reasons, to use a common feature extraction 11 for at least two gain mask predictors 12a, 12b, 12c.

With further reference to FIG. 3, it has been described that the audio processing system 110 according to some embodiments may comprise two or more source separation blocks 1a, 1b. Each source separation block 1a, 1b may comprise an individual common feature extraction block 11 preceding one or more gain mask predictors 12a, 12b, 12c as shown in FIG. 5. Advantageously, the audio object types which are to be extracted are grouped into a same source separation block 1a or 1b such that the spectrally similar audio object types are extracted by the same source separation block 1a or 1b. This facilitates training of the common feature extraction block 11 and/or enables use of a simpler feature extraction block 11 (e.g. with fewer neural network layers) with maintained performance since the common feature extraction block 11 may operate on spectrally similar audio content.

In the audio processing system 110 of FIG. 3 the scene classifier 2 is used alongside the speech-music separator 7. However, it is understood that the scene classifier 2 can be used without the speech-music separator 7 and vice-versa. For example, a scene classifier 2 can be used to adjust the levels of the height audio object types extracted by a single source separation block (e.g. lowering a gain level of a birdsong audio object type when the scene is identified as an indoor scene).

In FIG. 6 an alternative version of the source separation block 1 is depicted. Instead of utilizing a neural network based feature extractor and audio object separators the source separation block 1 may comprise a plurality of filters 15a, 15b, 15c configured to isolate a respective height/non-height audio object type. Each filter 15a, 15b, 15c may be a time- and/or or frequency-domain filter or a filterbank, e.g. QMF-filterbank. This version of the source separation block 1 is well suited for separation of audio object types that do not overlap, or only overlap to limited extent, in frequency domain.

One method for determining an appropriate pass-band for each filter 15a, 15b, 15c comprises first collecting sample audio content of the associated audio object (e.g. birdsong or helicopter sound). The more sample content that can be collected the better, but generally a few hours of sample audio content is sufficient. Secondly, the sample audio content is analyzed to determine over which frequencies the sample audio content is distributed. Using the information indicating the frequencies over which the sample audio content is distributed a suitable filter for separating the audio object can be designed. The resulting filter may be referred to as a soft-mask over a set of frequency bands. Preferably, the soft-mask does not feature a sharp cut-off in frequency but rather resembles a smoothed version of the EQ-characteristics of the audio object type.

Optionally, the equalization characteristics of the energy within the frequency band of the audio object are also determined. In some embodiments, filtering the input signal with the audio object specific filters further comprises performing equalization processing using equalization characteristics of the target audio object.

A filter-based implementation of the source separation block 1 can be made very computationally efficient and can be applied to both time- and frequency-domain representations of the input audio signal. However, it works best for audio objects that are clearly distinguishable in frequency.

The filter-based source separation block 1 may be provided with non-audio contextual data and/or information regarding the acoustic scene allowing for example the filters to be fine-tuned (in terms of pass band, roll-off, center-frequency etc.) based on the context or scene.

With reference to FIG. 7 the process of rendering at least one height audio object type and the non-height audio object types to a 2.0.2 presentation will now be described, however it is understood that a similar process can be carried out to render the audio objects to a different presentation format with height channels, such as to a 5.1.2 or 7.1.2 presentation.

The 2.0.2 presentation format comprises four channels, two horizontal channels referred to as the 2.0.0 channels, and two height channels referred to as the 0.0.2 channels. The 2.0.2 format is for example suitable for playback on a media system 200 having four loudspeakers 201a-d and a display, with two loudspeakers 201a, 201b being located above the center line of the display 202 and two loudspeakers 201c, 201d located below the center line of the display 202, as schematically shown in FIG. 7. The media system 200 may e.g. be a tablet 210 held horizontally (as often is the case when the tablet 210 is used to consume media content). However also other types of media systems are possible, such as a laptop or even a TV and one or more of the loudspeakers with a corresponding spatial relationship to the display as the loudspeakers 201a-d to the display 202.

Rendering the at least one height audio object type and the non-height audio object types to the 2.0.2 format may comprise rendering the height audio object type to only the two loudspeakers 201a, 201b located above the screen 202 and rendering the non-height audio object types to all four loudspeakers 201a-d. In this way, the height audio object types will be perceived by the user as originating from a position above the display 202, or above the user, whereas the non-height audio object types are rendered more homogenously in the horizontal plane and with more rendering energy. The non-height audio object types will thus be perceived by the user as originating from the center of the display 202.

Optionally, prior to rendering the height audio object types to the two top loudspeakers 201a, 201b the height audio object types are processed with a cross-talk-cancellation processor (see FIG. 1 and FIG. 3) that is configured to process the height audio object types such that when these are rendered to the two top loudspeakers 201a, 201b the cross-talk between these loudspeakers 201a, 201b and the user's ears is reduced, or removed. With cross-talk it is meant the audio outputted by the right top speaker 201b reaching the left ear of the user situated in front of the media system 200 and the audio outputted by the left top speaker 201a reaching the right ear of the user. Using cross-talk-cancellation, the audio object types to be rendered are adapted so as to form a virtual channel between the left top speaker and left ear and right top speaker and right ear, respectively. In effect, this allows the user to perceive an acoustic image that is very similar to listening to binaural headphones.

In some embodiments of cross-talk-cancellation, the method involves estimating four impulse responses, one being the impulse response between the left loudspeaker 201a and left ear, H_{LL}, one being between the right loudspeaker 201b and left ear, H_{RL}, one being between the left loudspeaker 201a and right ear, H_{LR}, and one being between the right loudspeaker 201b and right ear, H_{RR}. Using these impulse responses, H_{LL}, H_{RL}, H_{LR}, H_{RR} and their inverses, the cross-talk-cancellation processor processes the audio signals that are to be rendered to the top loudspeakers to achieve cross-talk-cancellation.

Cross-talk-cancellation is especially beneficial when the input audio signal is a recorded binaural audio signal. For binaural input audio signals there may already exist some spatial properties included in the binaural audio signals and these properties may be kept also for the extracted height/non-height audio object types. For example, while the height of an audio object may not be distinguishable from a binaural audio signal, a binaural audio signal comprises some information indicating if an audio object is located to the left or right. To this end, when a binaural height audio object type is extracted and rendered, the left-right information may be preserved in addition to the binaural audio object being rendered to the height channels multi-channel presentation. With cross-talk-cancellation, the binaural properties of the audio object types can at least partially be maintained even if the user is listening to the rendered presentation via loudspeakers instead of via headphones.

For a more accurate cross-talk-cancellation it may be beneficial to determine, in substantially real-time, how the user is oriented in front of the media system 200 (e.g. to continuously update an estimation of the impulse response functions). To accomplish this, a motion tracker may be used to monitor the motion of the user's head to adjust the cross-talk-cancellation of the height channels rendered to be perceived by the user accordingly. As one example, video based head-tracking using e.g. a camera connected to, or integrated in, the media system 200 can be used to perform the motion tracking and adjust the cross-talk-cancellation accordingly.

Alternatively, it is also possible to perform cross-talk-cancellation by assuming that the user is located in front of the media system 200 at a predetermined position (sometimes referred to as the sweet-spot) facing the display 202. While this assumption is not always accurate (e.g. due to the user moving his or head), it is envisaged that it nevertheless may offer a convincing binaural effect under typical viewing scenarios.

Unless specifically stated otherwise, as apparent from the following discussions, it is appreciated that throughout the disclosure discussions utilizing terms such as “processing”, “computing”, “calculating”, “determining”, “analyzing” or the like, refer to the action and/or processes of a computer hardware or computing system, or similar electronic computing devices, that manipulate and/or transform data represented as physical, such as electronic, quantities into other data similarly represented as physical quantities.

It should be appreciated that in the above description of exemplary embodiments of the invention, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention. Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with instructions for carrying out such a method or element of a method forms a means for carrying out the method or element of a method. Note that when the method includes several elements, e.g., several steps, no ordering of such elements is implied, unless specifically stated. Furthermore, an element described herein of an apparatus embodiment is an example of a means for carrying out the function performed by the element for the purpose of carrying out the embodiments of the invention. In the description provided herein, numerous specific details are set forth. However, it is understood that embodiments of the invention may be practiced without these specific details. In other instances, well-known methods, structures and techniques have not been shown in detail in order not to obscure an understanding of this description.

Thus, while there has been described specific embodiments of the invention, those skilled in the art will recognize that other and further modifications may be made thereto without departing from the spirit of the invention, and it is intended to claim all such changes and modifications as falling within the scope of the invention.

Various aspects of the present invention may be appreciated from the following Enumerated Example Embodiments (EEEs):

EEE 1. A method of processing audio, comprising: receiving an input audio signal; extracting, from the input audio signal, an audio object that is associated with height information; and rendering the audio object according to the height information using multi-speaker rendering.

EEE 2. The method of EEE 1, wherein the input audio signal is a binaural signal.

EEE 3. The method of any of EEEs 1 or 2, wherein extracting the audio object comprises utilizing audio scene classification to guide object extraction.

EEE 4. The method of any of EEEs 1-3, wherein extracting the audio object is performed based on frequency band distribution characteristics.

EEE 5. The method of any of EEEs 1-4, wherein extracting the audio object is performed based on deep learning.

EEE 6. The method of EEE 1, wherein the input audio signal includes a height channel provided through multi-device capture.

EEE 7. The method of any of EEEs 1-6, wherein rendering the audio object comprises performing cross-cancellation of speakers on a 0.0.2 channel without upmixing a binaural signal.

EEE 8. A system including one or more processors configured to perform operations of any of EEEs 1-7.

10 EEE 9. A computer program product configured to cause one or more processors to perform operations of any of EEEs 1-7.

1. A method for processing audio comprising:
obtaining an input audio signal;
processing the input audio signal to extract at least one height audio object from the input audio signal, wherein the at least one height audio object is extracted using a source separation module configured to extract audio objects of a predetermined height audio source type; and
rendering the input audio signal to a multi-channel presentation such that the at least one height audio object is at least included in at least one height channel of the multi-channel presentation.

2. The method according to claim 1, wherein the height audio source type comprises at least one of sounds made by manmade objects associated with height, sounds made by alive objects associated with height and sounds of nature associated with height.

3. The method according to claim 2, wherein the manmade sounds associated with height comprises at least one of: the sound of blade rotating in the air, the sound caused by manmade objects moving through the air and the sound of combustion, and/or wherein the sounds made by alive objects associated with height comprises at least one of: sound associated with an animal using aerial locomotion and sound associated arboreal animals, and/or wherein the sounds of nature associated with height comprises at least one of sound associated with weather and sound associated with landscape features.

4. The method according to claim 1, further comprising:
processing the input audio signal to extract at least two height audio objects, wherein the at least two height audio objects are extracted using a respective one of at least two source separation modules, each configured to extract a respective height audio object of a respective height audio source type; and
rendering the input audio signal to the multi-channel presentation such that the at least two height audio objects are included in at least one height channel of the multi-channel presentation.

5. The method according to claim 1, wherein the input audio signal is a binaural audio signal.

6. The method according to claim 5, wherein the at least one height audio object is a binaural audio signal and wherein rendering the input audio signal to a multi-channel presentation comprises:
rendering the input audio signal such that the at least one height audio object is presented in at least two height channels of the multi-channel presentation.

7. The method according to claim 1, wherein each source separation module is configured to process the input audio signal with a respective frequency filter, wherein a pass band of each respective frequency filter corresponds to a characteristic frequency range of the associated height audio source type.

8. The method according to claim 1, wherein each source separation module comprises a neural network trained to extract a height audio object of the respective predetermined height audio source type.

9. (canceled)

10. The method according to claim 1, further comprising:
identifying, with a scene classifier, an acoustic scene type of the input audio signal by processing the input audio signal.

11. The method according to claim 1, further comprising:
identifying, with a scene classifier, an acoustic scene type of the input audio signal by processing non-audio contextual, wherein the non-audio contextual data comprises at least one of: data indicating a media capture mode, a result of semantic or keyword analysis of the input audio signal, geographical position data associated with the input audio signal, data associated with an image or video captured concurrently with the input audio signal.

12. The method according to claim 10, further comprising:
controlling a gain of the at least one height audio object in the multi-channel presentation based on the acoustic scene type.

13. (canceled)

14. The method according to claim 10, further comprising:
processing the input audio signal with at least two source separation modules to extract at least a first height audio object associated with a first acoustic scene type and a second height audio object associated with a second acoustic scene type different than the first acoustic scene type, wherein each of the least two source separation modules is configured to extract a respective height audio object of a respective predetermined height audio source type;
determining whether the first acoustic scene type matches the identified acoustic scene type; and
in accordance with a determination that the first acoustic scene type matches the identified acoustic scene type, rendering the input audio signal to a multi-channel presentation such that, out of the first and second height audio object, only the first height audio object is included in the at least one height channel of the multi-channel presentation.

15. The method according to claim 14, further comprising:
in accordance with a determination that the first acoustic scene type does not match the identified acoustic scene type, rendering the input audio signal to a multi-channel presentation such that, out of the first and second height audio object, only the second height audio object is included in the at least one height channel of the multi-channel presentation.

16. The method according to claim 1, further comprising:
processing the input audio signal with a content separator to extract an audio signal associated with a first content type and a second content type, respectively, wherein the first content type is music and the second content type is speech;
processing the audio signal associated with the first content type to extract a first height audio object, wherein the first height audio object is extracted using a first source separation module associated with the first content type;
processing the audio signal associated with the second content type to extract a second height audio object, wherein the second height audio object is extracted using a second source separation module associated with the second content type; and
rendering the input audio signal to the multi-channel presentation such that the first and second height audio objects are included in at least one height channel of the multi-channel presentation.

17. (canceled)

18. The method according to claim 1, further comprising:
processing the input audio signal to extract a non-height audio object from the input audio signal, wherein the non-height audio object is extracted using a source separation module configured to extract an audio object of a predetermined non-height audio source type; and
wherein rendering the input audio signal further comprises:
rendering the non-height audio object to at least one non-height channel of the multi-channel presentation.

19. (canceled)

20. The method according to claim 1, further comprising:
obtaining a multi-channel source audio signal, the source audio signal comprising at least one non-height channel and a height channel, wherein the at least one non-height channel is used as the input audio signal; and
rendering the input audio signal and the height channel to a multi-channel presentation such that the at least one height audio object, extracted from the input audio signal, and the height channel of the source audio signal are included in the at least one height channel of the multi-channel presentation.

21. The method according to claim 1, wherein the multi-channel presentation comprises at least two height channels, the method further comprising:
processing the height audio object with a cross-talk-cancellation module to reduce or remove cross-talk between the at least two height channels for the height audio object when the height audio object is rendered.

22. The method according to claim 1, wherein the multi-channel presentation comprises at least two non-height channels, the method further comprising:
processing at least one non-height audio objects of the input audio signal with a cross-talk-cancellation module to reduce or remove cross-talk between the at least two non-height channels for the at least one non-height audio object when the at least one non-height audio object is rendered.

23. The method according to claim 1, further comprising:
obtaining non-audio contextual data, wherein the non-audio contextual data comprises at least one of: data indicating a media capture mode, a result of semantic or keyword analysis of the input audio signal, geographical position data associated with the input audio signal, data associated with an image or video captured concurrently with the input audio signal; and
wherein the source separation module is configured to extract audio objects of the predetermined height audio source type based on the non-audio contextual data.

24. The method according to claim 1, further comprising:
obtaining non-audio contextual data, wherein the non-audio contextual data comprises at least one of: data indicating a media capture mode, a result of semantic or keyword analysis of the input audio signal, geographical position data associated with the input audio signal, data associated with an image or video captured concurrently with the input audio signal; and
selecting, the source separation module from a group of source separation modules based on the non-audio contextual data, wherein the group of source separation modules comprises a plurality of source separation modules, each source separation module associated with a height audio object of a predetermined height audio source type and each source separation module associated with a type of non-audio contextual data.

25. (canceled)

26. A computer-readable storage medium storing a computer program including executable instructions for:
obtaining an input audio signal;
processing the input audio signal to extract at least one height audio object from the input audio signal, wherein the at least one height audio object is extracted using a source separation module configured to extract audio objects of a predetermined height audio source type; and
rendering the input audio signal to a multi-channel presentation such that the at least one height audio object is at least included in at least one height channel of the multi-channel presentation.

27. A system comprising:
one or more processors; and
a memory including a computer program including executable instructions for:
obtaining an input audio signal;
processing the input audio signal to extract at least one height audio object from the input audio signal, wherein the at least one height audio object is extracted using a source separation module configured to extract audio objects of a predetermined height audio source type; and
rendering the input audio signal to a multi-channel presentation such that the at least one height audio object is at least included in at least one height channel of the multi-channel presentation.
